(19) United States
(12) Patent Application Publication
(10) Pub. No.: US 2011/0151861 A1
(43) Pub. Date: Jun. 23, 2011

(54) SMART ALL-IN-ONE BASE STATION AND OPERATION METHOD THEREOF

(75) Inventors: Byung Jo Kim, Daejeon (KR); Bon Tae Koo, Daejeon (KR)

(73) Assignee: Electronics and Telecommunications Research Institute, Daejeon (KR)

(21) Appl. No.: 12/861,130

(22) Filed: Aug. 23, 2010

(30) Foreign Application Priority Data
Dec. 22, 2009 (KR) 10-2009-0128760

(51) Int. Cl. H04W 88/08; H04W 24/00

(52) U.S. Cl. 455/424; 455/561

(57) ABSTRACT

There are provided a smart all-in-one base station and an operation method thereof including: an interface unit that includes a plurality of interfaces supporting different communications protocols; a control unit that selects one of the plurality of interfaces included in the interface unit in consideration of user terminal information, interface information, and quality of service information and controls the connection of the user terminals and the selected interfaces; and a core network connection unit that connects the interfaces selected by the control unit to a wired network.

### CROSS-REFERENCE TO RELATED APPLICATIONS

This application claims the priority of Korean Patent Application No. 10-2009-0128760 filed on Dec. 22, 2009, in the Korean Intellectual Property Office, the disclosure of which is incorporated herein by reference.

### BACKGROUND OF THE INVENTION

1. Field of the Invention

The present invention relates to a smart all-in-one base station and an operation method thereof and more particularly, to a technology capable of selecting optimal interfaces of interfaces supporting various protocols while supporting various mobile communications protocols and wireless communications protocols and providing services to users via the selected optimal interfaces in order to guarantee link quality and data speed requested by the user and to improve the convenience and reliability thereof for the user.

2. Description of the Related Art

In general, a femtocell is an ultra mobile telecommunications base station that can be installed in an indoor space such as in a home or an office. The femtocell connects mobile phones to a wired network so as to remove a shadow area of mobile communications services and can be used as an element of indoor communications infrastructure or an indoor communications hub for providing fixed-mobile convergence services. A femtocell-based all-in-one base station may be an ultra mobile telecommunications base station that can realize high-quality fixed-mobile convergence services at low cost by connecting mobile phones (for example, 3G LTE, WCDMA, WiMAX, WiBro, and so on) in an environment such as a home, an office, a department store, and a public conveyance as well as connecting wireless local area networks (802.11 W-LAN, 802.15 Bluetooth/UWB, 60 GHz W-LAN, and so on) to wired networks (Internet network, CATV network, and so on).

However, there is no existing technology allowing a femtocell-based all-in-one base station to select optimal communications protocols by reflecting the demands of user terminals and a communications environment among various communications protocols and to provide services via optimal communications protocols.

### SUMMARY OF THE INVENTION

An aspect of the present invention provides a smart all-in-one base station capable of selecting optimal interfaces of interfaces supporting various protocols while supporting various mobile communications protocols and wireless communications protocols and providing services to users via the selected optimal interfaces in order to guarantee link quality and data speed requested by the user and to improve the convenience and reliability thereof for the user and an operation method thereof.

According to an aspect of the present invention, there is provided a smart all-in-one base station including: an interface unit that includes a plurality of interfaces supporting different communications protocols; a control unit that selects one of the plurality of interfaces included in the interface unit in consideration of user terminal information, interface information, and quality of service information and controls the connection of the user terminals to the selected interfaces; and a core network connection unit that connects the interfaces selected by the control unit to a wired network.

According to another aspect of the present invention, there is provided an operation method of a smart all-in-one base station including: initiating capacity and interference of a plurality of interfaces including the smart all-in-one base station; transmitting interface information accessible to user terminals by recognizing communications protocols supportable in the user terminals; measuring the interference and capacity of the accessible interfaces; determining whether the measured interference and capacity meet the predetermined conditions; if it is determined that the measured interference and capacity meet the predetermined conditions, determining whether the link quality and the data speed of the user terminals meet the predetermined conditions; and if it is determined that the link quality and the data speed meet the predetermined conditions, providing communications services via the accessible interfaces.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a smart all-in-one base station according to an exemplary embodiment of the present invention;

FIG. 2 is a diagram showing one example in which the smart all-in-one base station according to an exemplary embodiment of the present invention provides services within macrocells and femtocells; and

FIG. 3 is a flow chart showing an operation method of a smart all-in-one base station according to an exemplary embodiment of the present invention.

### DETAILED DESCRIPTION OF THE PREFERRED EMBODIMENT

Exemplary embodiments will now be described in detail with reference to the accompanying drawings so that they can be easily practiced by a person skilled in the art to which the present invention pertains. However, in describing the exemplary embodiments of the present invention, detailed descriptions of well-known functions or constructions are omitted so as not to obscure the description of the present invention with unnecessary detail. In addition, like reference numerals denote parts performing similar functions and actions throughout the drawings.

Throughout this specification, when it is described that an element is “connected” to another element, the element may be “directly connected” to another element or “indirectly connected” to another element through a third element. In addition, unless explicitly described otherwise, “comprising” any components will understood to imply the inclusion of other components but not the exclusion of any other components.

A smart all-in-one base station according to the present invention is installed in an indoor environment such as in a home, an office, a department store, a train, a bus, and so on, so as to select interfaces providing an optimal communications environment among a plurality of interfaces supporting various communications protocols, thereby providing optimal communications services. The smart all-in-one base station can also be applied to single-mode terminals as well as multi-mode terminals.

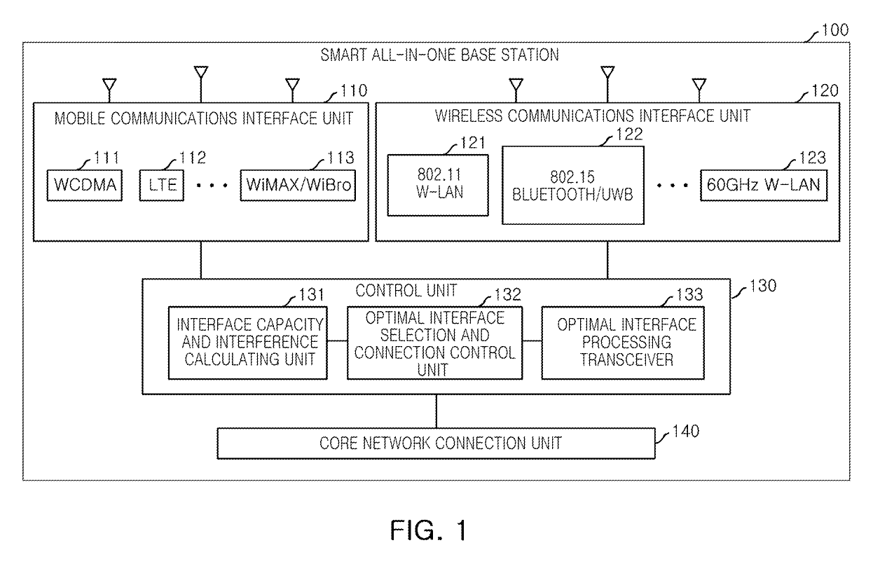

FIG. 1 is a configuration diagram of a smart all-in-one base station according to an exemplary embodiment of the present invention. The smart all-in-one base station 100 is configured to include a mobile communications interface unit 110 that provides communications services according to various mobile communications protocols, a wireless communications interface unit 120 that provides communications services according to various wireless communications protocols, a control unit 130 that selects optimal interfaces of interfaces supporting various communications protocols included in the mobile communications interface unit 110 and the wireless communications interface unit 120 to control the connection of user terminals, and a core network connection unit 140 that connects a wired network with the interfaces selected by the control unit 130.

The mobile communications interface unit 110 is configured to include a plurality of interfaces supporting various mobile communications protocols. For example, the mobile communications interface unit 110 may include interfaces supporting the mobile communications protocols such as wideband code division multiple access (WCDMA) 111, a long term evolution (LTE) 112, a WiMax/WiBro 113, and so on. The interfaces supporting each mobile communications protocol may be implemented by a general technology widely known to those skilled in the art and therefore, a detailed description thereof will be omitted.

The wireless communications interface unit 120 is configured to include the plurality of interfaces supporting various wireless communications protocols. For example, the wireless communications interface unit 120 may include interfaces supporting the wireless communications protocols such as an 802.11 W-LAN 121, an 802.15 Bluetooth/UWB, a 60 GHz W-LAN 123, and so on. The interfaces supporting each wireless communications protocol may be implemented by a general technology widely known to those skilled in the art and therefore, a detailed description thereof will be omitted.

The control unit 130 selects the optimal interfaces of the interfaces supporting various communications protocols included in the mobile communications interface unit 110 and the wireless communications interface unit 120 to control the connection thereof. More specifically, the control unit 130 may be configured to include an interface capacity and interference calculating unit 131, an optimal interface selection and connection control unit 132, and an optimal interface processing transceiver 133.

The interface capacity and interference calculating unit 131 calculates the capacity and interference of each interface included in the mobile communications interface unit 110 and the wireless communications interface unit 120 and transfers the calculated results to the optimal interface selection and connection control unit 132. The capacity and interference of the interfaces can be calculated by various algorithms that are known in the related art.

The optimal interface selection and connection control unit 132 selects the optimal interfaces and controls the connection, in consideration of the mode of the user terminals (i.e., communications protocol supported by the user terminals), the capacity and interference of the interfaces, the communications link quality, the data speed, the coverage of the user terminals, idle interfaces, adjacent available base stations, and so on.

The optimal interface processing transceiver 133 informs the adjacent smart all-in-one base stations, the macrocell base stations, the user terminals, and so on, of the optimal interface information selected by the optimal interface selection and connection control unit 132 and receives a response thereto.

The control unit 130 including the above-mentioned components selects the optimal interfaces in consideration of the mode of the user terminals, the coverage of the user terminals, the idle interfaces, the adjacent smart all-in-one base stations, and so on, when the capacity of the corresponding interfaces is lacking or the interference thereof exceeds the predetermined conditions by first calculating the capacity and interference of the interfaces to which the user terminals access or when the capacity and interference of the interface are proper but the link quality or the data speed does not meet the requirements.

Further, the control unit 130 can support the multi-mode protocols to provide the maximum services requested by the user terminals having top priority according to the priority of the user terminals.

The core network connection unit 140 connects the mobile communications interface unit 110 and the wireless communications interface unit 120 with the wired networks such as an Internet network, a CATV, and so on.

Although not shown in FIG. 1, the smart all-in-one base station 100 may further include MACs that are provided in the base stations of the related art to process and control data of each communications protocol, a memory that stores data, and so on.

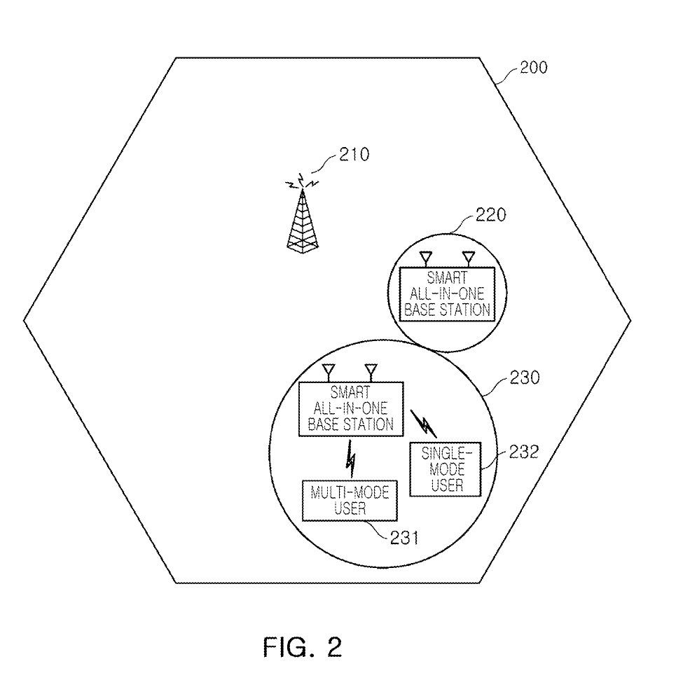

FIG. 2 is a diagram showing one example in which the smart all-in-one base station according to an exemplary embodiment of the present invention provides services within the macrocell and the femtocell.

Referring to FIG. 2, femtocells 220 and 230, receiving services provided by the femtocell-based smart all-in-one base station, overlap within a macrocell 200 receiving services provided by macrocell base station 210 and a multi-mode user 231 and a single-mode user 232 positioned in the femtocell 230 receive services via the smart all-in-one base station of the corresponding femtocell 230.

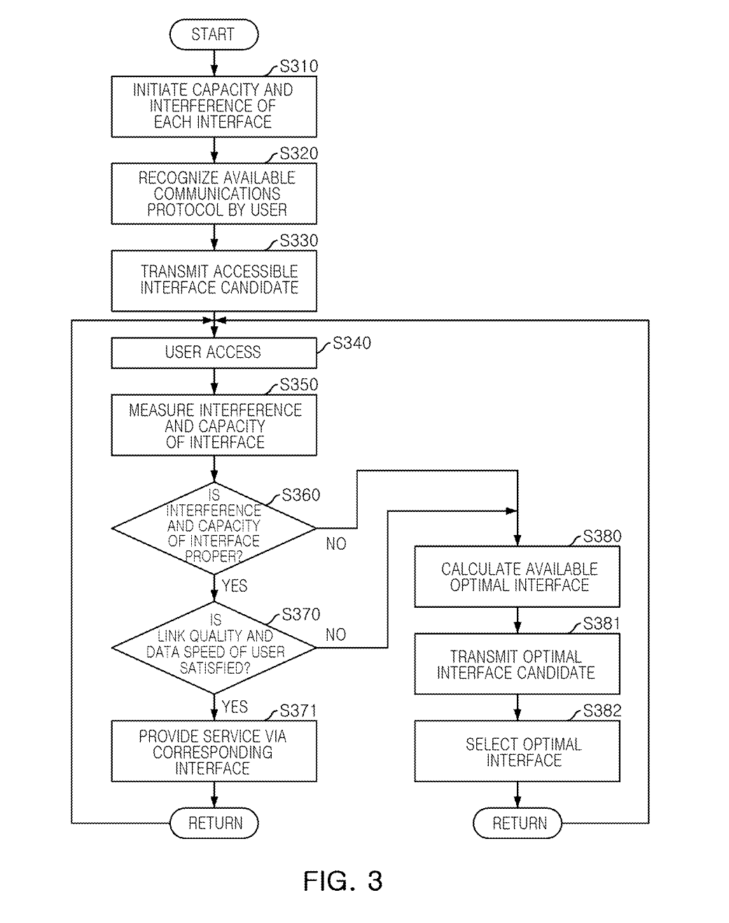

FIG. 3 is a flow chart of an operational process of a smart all-in-one base station according to another exemplary embodiment of the present invention.

When the operation of the smart all-in-one base station according to the present invention starts, the capacity and interference of each interface supporting various mobile communications protocols or various wireless communications protocols included in the smart all-in-one base station are initiated (S310).

Thereafter, the smart all-in-one base station recognizes the supportable communications protocols at the user terminals (S320) and then, transmits accessible interface candidate information to the user terminals (S330).

Next, when the user terminals access the smart all-in-one base station (S340), the interference and capacity of the interfaces selected as the accessible interface candidate are measured (S350).

Then, it is determined whether the measured interference and capacity of the interface are proper, that is, whether the interference of the interface exceeds the predetermined conditions or the capacity of the interface is lack (S360).

In addition, if it is determined that the measured interference and capacity of the interface are proper, it is determined whether the link quality and the data speed requested by the user meet the requirements (S370).

According to the determination result, if it is determined that the interference and capacity are proper and the link quality and the data speed also satisfy the requirements, the communications services are provided via the interfaces selected as the candidate (S371).

On the other hand, if it is determined that the measured interference or capacity of the interface are improper or the link quality of the user or the data speed does not meet the requirements, the optimal interfaces are calculated in consideration of the communications protocols supported by the user terminals, the coverage of the user terminals, information on the idle interfaces and the adjacent available base stations, and so on (S380). At this time, when there are replaceable idle interfaces in the corresponding smart all-in-one base station, it is selected and otherwise, the adjacent smart all-in-one base station may be selected.

Thereafter, the optimal interface candidate information is transmitted to the adjacent smart all-in-one base station, the macrocell base stations, and the user terminals, etc. (S381), and thus, the user terminals select the interfaces supporting the optimal communications protocols, thereby making it possible to receive the communications services (S382).

As set forth above, according to exemplary embodiments of the present invention, the smart all-in-one base station can select the interfaces supporting the optimal communication protocols of various communication protocols depending on the demands of the user terminals and the communication environment while supporting various mobile communication protocols and wireless communication protocols and provide services through the interfaces.

While the present invention has been shown and described in connection with the exemplary embodiments, it will be apparent to those skilled in the art that modifications and variations can be made without departing from the spirit and scope of the invention as defined by the appended claims.

What is claimed is:

1. A smart all-in-one base station, comprising:
an interface unit that includes a plurality of interfaces supporting different communications protocols;
a control unit that selects one of the plurality of interfaces included in the interface unit in consideration of user terminal information, interface information, and quality of service information and controls the connection of the user terminals and the selected interfaces; and
a core network connection unit that connects the interfaces selected by the control unit to a wired network.

2. The smart all-in-one base station of claim 1, wherein the interface unit includes:
a mobile communications interface unit that includes the plurality of mobile communications interfaces supporting different mobile communications protocols; and
a wireless communications interface unit that includes the plurality of wireless communications interfaces supporting different wireless communications protocols.

3. The smart all-in-one base station of claim 2, wherein the mobile communications interface unit includes a plurality of mobile communications interfaces supporting mobile communications protocols selected in a wideband code division multiple access (WCDMA), a long term evolution (LTE), a WiMax, and a WiBro.

4. The smart all-in-one base station of claim 2, wherein the wireless communications interface unit includes a plurality of wireless communications interfaces supporting a plurality of wireless communications protocols that are selected in a 802.11 W-LAN, a 802.15 Bluetooth/UWB, and a 60 GHz W-LAN.

5. The smart all-in-one base station of claim 1, wherein the control unit includes:
an interface capacity and interference calculating unit that calculates the capacity and interference of the plurality of interfaces included in the interface unit;
an optimal interface selection and connection control unit that selects the optimal interfaces and controls the connection, in consideration of the capacity and interference of the interface calculated by the interface capacity and interference calculating unit, the mode and coverage of the user terminals, communications link quality, data speed, information on idle interfaces and adjacent available base stations; and
an optimal interface processing transceiver that informs the adjacent smart all-in-one base station, macrocell base stations, and the user terminals of the selected optimal interface information.

6. An operation method of a smart all-in-one base station, comprising:
initiating capacity and interference of a plurality of interfaces included in the smart all-in-one base station;
transmitting interface information accessible to user terminals by recognizing communications protocols supportable in the user terminals;
measuring the interference and capacity of the accessible interfaces;
determining whether the measured interference and capacity meet the predetermined conditions;
if it is determined that the measured interference and capacity meet the predetermined conditions, determining whether the link quality and the data speed of the user terminals meet the predetermined conditions; and
if it is determined that the link quality and the data speed meet the predetermined conditions, providing communications services via the accessible interfaces.

7. The operation method of smart all-in-one base station of claim 6, further comprising:
if it is determined that the measured interference or capacity does not meet the predetermined conditions or the link quality or the data speed does not meet the predetermined conditions,
selecting optimal interfaces in consideration of mode and coverage of user terminals, idle interfaces, and information on adjacent available base stations;
transmitting the information on the selected optimal interfaces to adjacent smart all-in-one base stations, macrocell base stations, and user terminals; and
providing services via the selected optimal interfaces.
